(19) United States
(12) Patent Application Publication
(10) Pub. No.: US 2021/0368209 A1
(43) Pub. Date: Nov. 25, 2021

(54) GENERAL CONSTRAINT INFORMATION SIGNALING IN VIDEO CODING

(71) Applicant: QUALCOMM Incorporated, San Diego, CA (US)

(72) Inventors: Muhammed Zeyd Coban, Carlsbad, CA (US); Vadim Seregin, San Diego, CA (US); Yong He, San Diego, CA (US); Yao-Jen Chang, San Diego, CA (US)

(21) Appl. No.: 17/325,683

(22) Filed: May 20, 2021

Related U.S. Application Data
(60) Provisional application No. 63/028,425, filed on May 21, 2020.

(51) Int. Cl. H04N 19/70; H04N 19/146; H04N 19/169; H04N 19/184

(52) U.S. Cl. CPC H04N 19/70; H04N 19/184; H04N 19/1883; H04N 19/146

(57) ABSTRACT

A method of processing video data, the method comprising: decoding a syntax element in a profile tier level syntax structure in a bitstream that includes an encoded representation of the video data; and based on a value of the syntax element being equal to 0, inferring that all constraint fields in a general constraint information syntax structure have values indicating that constraints corresponding to the constraint fields do not apply to the bitstream.

This application claims the benefit of U.S. Provisional Patent Application 63/028,425, filed May 21, 2020, the entire content of which is incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for signaling of general constraint information in video coding. As described herein, a profile tier level (PTL) syntax structure in a bitstream may include a set of constraint fields. There may be numerous constraint fields, which may unnecessarily increase the size of the bitstream when sufficient information about the bitstream may be obtained from profile and tier flags in the PTL syntax structure. To address this technical problem a syntax element may be used to determine whether the PTL syntax structure includes the constraint fields. This may reduce the size of the bitstream in some circumstances.

In one example, this disclosure describes a method of processing video data, the method including: decoding a syntax element in a profile tier level syntax structure in a bitstream that includes an encoded representation of the video data; and based on a value of the syntax element being equal to 0, inferring that all constraint fields in a general constraint information syntax structure have values indicating that constraints corresponding to the constraint fields do not apply to the bitstream.

In another example, this disclosure describes a method of encoding video data, the method including: generating a bitstream that includes an encoded representation of the video data; and based on all constraint fields in a general constraint information structure having values indicating that constraints do not apply to the bitstream, encoding a syntax element in a profile tier level syntax structure in the bitstream, wherein the syntax element indicates that the profile tier level syntax structure does not include the constraint fields that specify whether the constraints apply to the bitstream.

In another example, this disclosure describes a device for processing video data, the device including: a memory to store the video data; and one or more processors implemented in circuitry, the one or more processors configured to: decode a syntax element in a profile tier level syntax structure in a bitstream that includes an encoded representation of the video data; and based on a value of the syntax element being equal to 0, infer that all constraint fields in a general constraint information syntax structure have values indicating that constraints corresponding to the constraint fields do not apply to the bitstream.

In another example, this disclosure describes a device for processing video data, the device including: a memory to store the video data; and one or more processors implemented in circuitry, the one or more processors configured to: generate a bitstream that includes an encoded representation of the video data; and based on all constraint fields in a general constraint information structure having values indicating that constraints do not apply to the bitstream, encode a syntax element in a profile tier level syntax structure in the bitstream, wherein the syntax element indicates that the profile tier level syntax structure does not include the constraint fields that specify whether the constraints apply to the bitstream.

In another example, this disclosure describes a device for processing video data, the device including: means for decoding a syntax element in a profile tier level syntax structure in a bitstream that includes an encoded representation of the video data; and means for inferring, based on a value of the syntax element being equal to 0, that all constraint fields in a general constraint information syntax structure have values indicating that constraints corresponding to the constraint fields do not apply to the bitstream.

In another example, this disclosure describes a device for encoding video data, the device including: means for generating a bitstream that includes an encoded representation of the video data; and means for encoding, based on all constraint fields in a general constraint information structure having values indicating that constraints do not apply to the bitstream, a syntax element in a profile tier level syntax structure in the bitstream, wherein the syntax element indicates that the profile tier level syntax structure does not include the constraint fields that specify whether the constraints apply to the bitstream.

In another example, this disclosure describes a computer-readable data storage medium having instructions stored thereon that, when executed, cause one or more processors to: decode a syntax element in a profile tier level syntax structure in a bitstream that includes an encoded representation of the video data; and based on a value of the syntax element being equal to 0, infer that all constraint fields in a general constraint information syntax structure have values indicating that constraints corresponding to the constraint fields do not apply to the bitstream.

In another example, this disclosure describes a computer-readable data storage medium having instructions stored thereon that, when executed, cause one or more processors to: generate a bitstream that includes an encoded representation of the video data; and based on all constraint fields in a general constraint information structure having values indicating that constraints do not apply to the bitstream, encode a syntax element in a profile tier level syntax structure in the bitstream, wherein the syntax element indicates that the profile tier level syntax structure does not include the constraint fields that specify whether the constraints apply to the bitstream.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram illustrating an example video encoder that may perform the techniques of this disclosure.

FIG. 3 is a block diagram illustrating an example video decoder that may perform the techniques of this disclosure.

FIG. 4 is a flowchart illustrating an example method for encoding a current block of video data.

FIG. 5 is a flowchart illustrating an example method for decoding a current block of video data.

FIG. 6 is a flowchart illustrating an example operation for encoding video data in accordance with one or more techniques of this disclosure.

FIG. 7 is a flowchart illustrating an example operation for processing video data in accordance with one or more techniques of this disclosure.

### DETAILED DESCRIPTION

A profile-tier-level (PTL) syntax structure is a syntax structure that includes information that may identify at least one of a profile, tier, or level of a bitstream containing the profile-tier-level syntax structure. A PTL syntax structure may be included in a decoding capability information (DCI) raw byte sequence payload (RBSP), a video parameter set (VPS), sequence parameter set (SPS), or another type of parameter set. The profile, tier, and level of a bitstream may indicate which coding tools may be required to decode the bitstream, ranges of values that may be produced during decoding of the bitstream, and/or other constraints. More precisely, a profile may be a subset of the entire bitstream syntax provided in a video codec, such as in Versatile Video Coding (VVC). Tiers and levels may be specified within each profile. A level of a tier may be a specified set of constraints imposed on values of syntax elements in the bitstream. A level specified for a lower tier is more constrained than a level specified for a higher tier.

The PTL syntax structure may include constraint fields that specify whether specific constraints apply to an in-scope output layer set of the bitstream. For example, one of the constraint fields may specify that an in-scope output layer set of the bitstream does not include any gradual decoding refresh (GDR) pictures. Another constraint field may specify that the in-scope output layer set of the bitstream does not use palette mode coding.

Each of the constraint fields may be encoded in the PTL syntax structure as a separate syntax element. In addition to the syntax elements that are used to encode the constraint fields, the PTL syntax structure may include a general profile syntax element, a general tier syntax element, and a general level syntax element. The general profile syntax element indicates a profile to which an in-scope output layer set conforms. The general tier syntax element specifies a tier context for interpretation of a general level indicator syntax element. The general level indicator syntax element indicates a level to which the in-scope output layer set conforms. A video decoder or other device may use information, such as constraint fields, in a PTL syntax structure to determine whether the video decoder is configured to decode the bitstream. For instance, a video encoder may encode a DCI RBSP in a first access unit (AU) of a bitstream or a DCI RBSP may be provided to a video decoder through a system external to the bitstream. The video decoder or other device may use information in the PTL syntax structure in the DCI RBSP to determine whether the video decoder is configured to decode the bitstream without decoding subsequent portions of the bitstream.

The number of constraint fields in a PTL syntax structure may be significant and may therefore contribute to the size of the bitstream. However, there may be cases where it is unnecessary for the bitstream to include the constraint fields. For instance, there may be cases where the values of the general profile syntax element and the general tier syntax element are sufficient to determine whether a video coder is configured to decode the bitstream. Thus, encoding the constraint fields in the bitstream may unnecessarily increase the size of the bitstream in some cases.

This disclosure describes techniques that may address this technical problem and reduce the size of the bitstream. For example, a video encoder may generate a bitstream that includes an encoded representation of the video data. Based on all constraint fields in a general constraint information structure having values indicating that constraints do not apply to the bitstream, the video encoder may encode a syntax element in a profile tier level syntax structure in the bitstream. The syntax element indicates that the profile tier level syntax structure does not include the constraint fields that specify whether the constraints apply to the bitstream. Similarly, a video decoder may decode a syntax element in a profile tier level syntax structure in a bitstream that includes an encoded representation of the video data. Based on a value of the syntax element being equal to a first value (e.g., 0), the video decoder may infer that all constraint fields in a general constraint information syntax structure have values indicating that constraints corresponding to the constraint fields do not apply to the bitstream. When the video decoder infers a value, such as a constraint field, the video decoder does not decode a syntax element from the bitstream that explicitly specifies the value. Rather, the video decoder may automatically determine the value. Conversely, based on the value of the syntax element being equal to a second value (e.g., 1), the video decoder may decode the constraint fields from the bitstream.

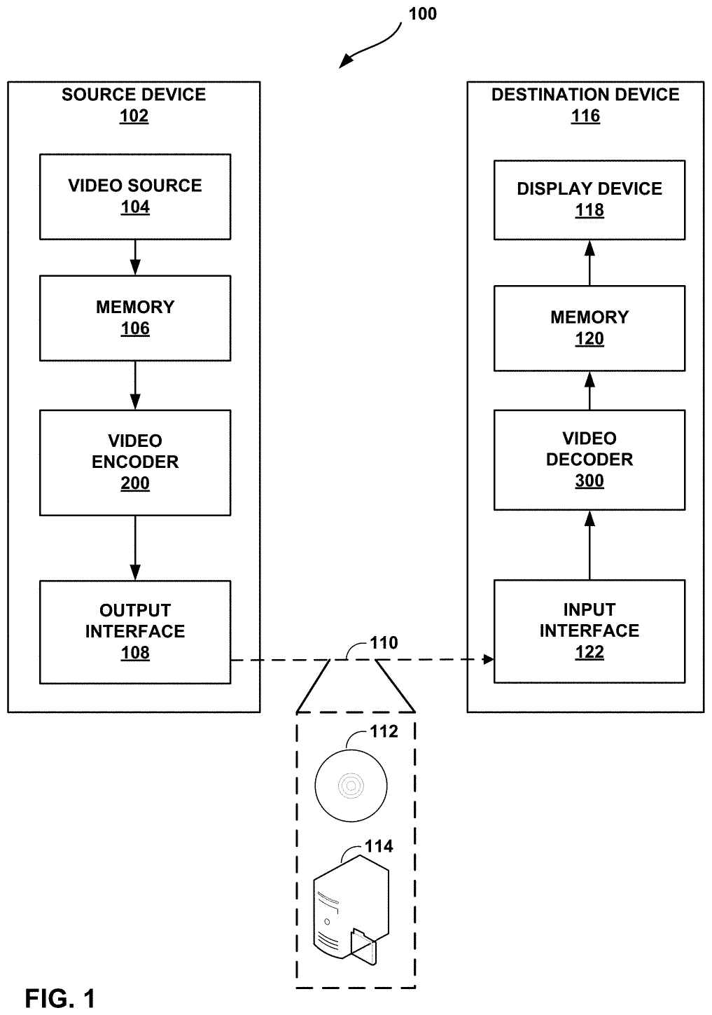

FIG. 1 is a block diagram illustrating an example video encoding and decoding system 100 that may perform the techniques of this disclosure. The techniques of this disclosure are generally directed to coding (encoding and/or decoding) video data. Processing video data may include using or handling video data in some fashion. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may include any of a wide range of devices, including desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for signaling of general constraint information. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for signaling of general constraint information. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may demodulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download. File server 114 may be any type of server device capable of storing encoded video data and transmitting that encoded video data to the destination device 116. File server 114 may represent a web server (e.g., for a website), a File Transfer Protocol (FTP) server, a content delivery network device, or a network attached storage (NAS) device. Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may include an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). A recent draft of the VVC standard is described in Bross, et al. “Versatile Video Coding (Draft 9),” Joint Video Experts Team (WET) of ITU-T SG 16 WP 3 and ISO/IEC JTC 1/SC 29/WG 11, 18^{th} Meeting: by teleconference, 15-24 Apr. 2020, WET-R2001-v10 (hereinafter “VVC Draft 9”). The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning per HEVC, QTBT partitioning, MTT partitioning, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

In VVC Draft 9, a general constraint information syntax structure (e.g., a general_constraint_info( ) syntax structure) is signaled in a profile tier level syntax structure (e.g., a profile_tier_level( ) syntax structure) when profileTierPresentFlag is set to 1. A portion of the profile tier level syntax structure as specified in VVC Draft 9 is provided below.

TABLE 1

Descriptor

profile_tier_level( profileTierPresentFlag, maxNumSubLayersMinus1 ) {

if( profileTierPresentFlag ) {

| | |
|---|---|
| general_profile_idc | u(7) |
| general_tier_flag | u(1) |
| general_constraint_info( ) | |

| | |
|---|---|
| } | |
| general_level_idc | u(8) |
| ... | |

In Table 1, the general_profile_idc syntax element is a general profile syntax element that indicates a profile to which an in-scope output layer set conforms. An output layer set may be a set of layers for which one or more layers are specified as the output layers. An output layer is a layer of an output layer set that is output. A layer is a set of video coding layer (VCL) NAL units that all have a particular layer identifier value and associated non-VCL NAL units. In Table 1, the profileTierPresentFlag is a variable indicating whether profile and tier information is present in the PTL syntax structure.

As shown in Table 1, the profile tier level syntax structure includes a general constraint information syntax structure (general_constraint_info( )). A copy of the general_constraint_info( ) syntax structure is provided in Table 2, below.

TABLE 2

Descriptor

general_constraint_info( ) {

| | |
|---|---|
| general_non_packed_constraint_flag | u(1) |
| general_frame_only_constraint_flag | u(1) |
| general_non_projected_constraint_flag | u(1) |
| general_one_picture_only_constraint_flag | u(1) |
| intra_only_constraint_flag | u(1) |
| max_bitdepth_constraint_idc | u(4) |
| max_chroma_format_constraint_idc | u(2) |
| single_layer_constraint_flag | u(1) |
| all_layers_independent_constraint_flag | u(1) |
| no_ref_pic_resampling_constraint_flag | u(1) |
| no_res_change_in_clvs_constraint_flag | u(1) |
| one_tile_per_pic_constraint_flag | u(1) |
| pic_header_in_slice_header_constraint_flag | u(1) |
| one_slice_per_pic_constraint_flag | u(1) |
| one_subpic_per_pic_constraint_flag | u(1) |
| no_qtbtt_dual_tree_intra_constraint_flag | u(1) |
| no_partition_constraints_override_constraint_flag | u(1) |
| no_sao_constraint_flag | u(1) |
| no_alf_constraint_flag | u(1) |
| no_ccalf_constraint_flag | u(1) |
| no_joint_cbcr_constraint_flag | u(1) |
| no_mrl_constraint_flag | u(1) |
| no_isp_constraint_flag | u(1) |
| no_mip_constraint_flag | u(1) |
| no_ref_wrap_around_constraint_flag | u(1) |
| no_temporal_mvp_constraint_flag | u(1) |
| no_sbtmvp_constraint_flag | u(1) |
| no_amvr_constraint_flag | u(1) |
| no_bdof_constraint_flag | u(1) |
| no_dmvr_constraint_flag | u(1) |
| no_cclm_constraint_flag | u(1) |
| no_mts_constraint_flag | u(1) |
| no_sbt_constraint_flag | u(1) |
| no_lfnst_constraint_flag | u(1) |
| no_affine_motion_constraint_flag | u(1) |
| no_mmvd_constraint_flag | u(1) |
| no_smvd_constraint_flag | u(1) |
| no_prof_constraint_flag | u(1) |
| no_bcw_constraint_flag | u(1) |
| no_ibc_constraint_flag | u(1) |
| no_ciip_constraint_flag | u(1) |
| no_gpm_constraint_flag | u(1) |
| no_ladf_constraint_flag | u(1) |
| no_transform_skip_constraint_flag | u(1) |
| no_bdpcm_constraint_flag | u(1) |
| no_palette_constraint_flag | u(1) |
| no_act_constraint_flag | u(1) |
| no_lmcs_constraint_flag | u(1) |
| no_cu_qp_delta_constraint_flag | u(1) |
| no_chroma_qp_offset_constraint_flag | u(1) |
| no_dep_quant_constraint_flag | u(1) |
| no_sign_data_hiding_constraint_flag | u(1) |
| no_tsrc_constraint_flag | u(1) |
| no_mixed_nalu_types_in_pic_constraint_flag | u(1) |
| no_trail_constraint_flag | u(1) |
| no_stsa_constraint_flag | u(1) |
| no_rasl_constraint_flag | u(1) |
| no_radl_constraint_flag | u(1) |
| no_idr_constraint_flag | u(1) |
| no_cra_constraint_flag | u(1) |
| no_gdr_constraint_flag | u(1) |
| no_aps_constraint_flag | u(1) |
| while( !byte_aligned( ) ) | |

| | |
|---|---|
| gci_alignment_zero_bit | f(1) |

| | |
|---|---|
| gci_num_reserved_bytes | u(8) |
| for( i = 0; i < gci_num_reserved_bytes; i++ ) | |

| | |
|---|---|
| gci_reserved_byte[ i ] | u(8) |

}

Each of the constraint flag syntax elements in the general constraint information syntax structure corresponds to a constraint field. Because of the large number of constraint flag syntax elements in the general constraint information syntax structure, the semantics of only some of the constraint flag syntax elements, as specified in VVC Draft 9, as provided in this disclosure.

no_ciip_constraint_flag equal to 1 specifies that sps_ciip_enabled_flag shall be equal to 0. no_cipp_constraint_flag equal to 0 does not impose such a constraint. When intra_only_constraint_flag is equal to 1, the value of no_cipp_constraint_flag shall be equal to 1.
. . .
no_palette_constraint_flag equal to 1 specifies that sps_palette_enabled flag shall be equal to 0. no_palette_constraint_flag equal to 0 does not impose such a constraint.
. . .
no_gdr_constraint_flag equal to 1 specifies that sps_gdr_enabled_flag shall be equal to 0. no_gdr_constraint_flag equal to 0 does not impose such a constraint.
. . .

In the semantics above, sps_ciip_enabled_flag specifies that ciip_flag may be present in the coding unit syntax for inter coding units. The ciip_flag specifies whether the combined inter-picture merge and intra-picture prediction is applied for the current coding unit. sps_palette_enabled_flag equal to 1 specifies that pred_mode_plt_flag may be present in the coding unit syntax of the coded layer video sequence (CLVS). sps_palette_enabled_flag equal to 0 specifies that pred_mode_plt_flag is not present in the coding unit syntax of the CLVS. pred_mode_plt_flag specifies the use of palette mode in the current coding unit. sps_gdr_enabled_flag equal to 1 specifies that GDR pictures are enabled and may be present in the CLVS.

There may be cases where only general_profile_idc and general_tier_flag need to be signaled without signaling the general_constraint_info( ) syntax structure when profileTierPresentFlag is set to 1. In other words, there may be cases where it may be sufficient to encode the general_profile_idc and general_tier_flag syntax elements without signaling the constraint fields in the general constraint information syntax structure. Encoding the constraint fields in such cases may be wasteful and may unnecessarily contribute to the size of the bitstream. Larger bitstreams may require more storage space and may take longer to transmit.

This disclosure describes techniques that may address this technical problem. For instance, this disclosure proposes adding a general constraint information present flag (e.g., general_constraint_info_present_flag) syntax element to gate (i.e., control) the presence of a general constraint information (e.g., general_constraint_info( )) syntax structure. When the general_constraint_info_present_flag is set to a first value (e.g., 0), all constraint fields in the general_constraint_info( ) syntax structure are inferred to have values equal to 0. The following example changes to VVC Draft 9 are set forth in the syntax table below. In Table 3, below, insertions are marked with <i> . . . </i> tags.

TABLE 3

Descriptor

profile_tier_level( profileTierPresentFlag, maxNumSubLayersMinus1 ) {

if( profileTierPresentFlag ) {

| | |
|---|---|
| general_profile_idc | u(7) |
| general_tier_flag | u(1) |
| <i>general_constraint_info_present_flag</i> | <i>u(1)</i> |
| <i>if( general_constraint_info_present_flag )</i> | |

general_constraint_info( )

| | |
|---|---|
| } | |
| general_level_idc | u(8) |
| if( profileTierPresentFlag ) { | |

| | |
|---|---|
| ptl_num_sub_profiles | u(8) |
| for( i = 0; i < ptl_num_sub_profiles; i++ ) | |

| | |
|---|---|
| general_sub_profile_idc[ i ] | u(32) |

}
for( i = 0; i < maxNumSubLayersMinus1; i++ )

| | |
|---|---|
| ptl_sublayer_level_present_flag[ i ] | u(1) |

while( !byte_aligned( ) )

| | |
|---|---|
| ptl_alignment_zero_bit | f(1) |

for( i = 0; i < maxNumSubLayersMinus1; i++ )

if( ptl_sublayer_level_present_flag[ i ] )

| | |
|---|---|
| sublayer_level_idc[ i ] | u(8) |

Furthermore, in accordance with one or more techniques of this disclosure, the semantics of the PTL (e.g., profile_tier_level) syntax structure may be modified as follows:

General Profile, Tier, and Level Semantics
A profile_tier_level( ) syntax structure provides level information and, optionally, profile, tier, sub-profile, and general constraints information.
When the profile_tier_level( ) syntax structure is included in a VPS, the OlsInScope is one or more OLSs specified by the VPS. When the profile_tier_level( ) syntax structure is included in an SPS, the OlsInScope is the OLS that includes only the layer that is the lowest layer among the layers that refer to the SPS, and this lowest layer is an independent layer.
general_profile_idc indicates a profile to which OlsInScope conforms as specified in Annex A. Bitstreams shall not contain values of general_profile_idc other than those specified in Annex A. Other values of general_profile_idc are reserved for future use by ITU-T|ISO/IEC.
general_tier_flag specifies the tier context for the interpretation of general_level_idc as specified in Annex A.
<i>general_constraint_info_present_flag equal to 1 specifies that profile_level_tier( ) syntax structure contains general_constraint_info( ) syntax structure. general_constraint_info_present flag equal to 0 specifies that contains general_constraint_info( ) syntax structure is not present in profile_level_tier( ) syntax structure.</i>

Additionally, in accordance with one or more techniques of this disclosure, the semantics of the general constraint information syntax structure may be modified as follows:

General Constraint Information Semantics
<i>When general_constraint_info_present_flag is equal to 0, all constraints fields in section 7.3.3.2 are inferred to be equal to 0. </i>
general_non_packed_constraint_flag equal to 1 specifies that there shall not be any frame packing arrangement SEI messages present in the bitstream of the OlsInScope. general_non_packed_constraint_flag equal to 0 does not impose such a constraint.
   NOTE 1—Decoders may ignore the value of general_non_packed_constraint_flag, as there are no decoding process requirements associated with the presence or interpretation of frame packing arrangement SEI messages.
general_frame_only_constraint_flag equal to 1 specifies that OlsInScope conveys pictures that represent frames. general_frame_only_constraint_flag equal to 0 specifies that OlsInScope conveys pictures that may or may not represent frames.

In accordance with the techniques of this disclosure, video encoder 200 may generate a bitstream that includes an encoded representation of the video data. In this example, based on all of the constraint fields in a general constraint information structure having values indicating that constraints do not apply to the bitstream, video encoder 200 may encode a syntax element in a profile tier level syntax structure in the bitstream, wherein the syntax element indicates that the profile tier level syntax structure does not include the constraint fields that specify whether the constraints apply to the bitstream

In some examples, video encoder 200 may signal, based on all of the constraint fields in a general constraint information structure having values indicating that constraints do not apply to a bitstream that includes an encoded representation of the video data, a syntax element in a profile tier level syntax structure in the bitstream, wherein the syntax element indicates that the profile tier level syntax structure does not include a general constraint information syntax structure that includes constraint fields that specify whether the constraints apply to the bitstream.

Furthermore, in some examples, video decoder 300 may decode a syntax element (e.g., general_constraint_info_present_flag) in a profile tier level syntax structure in a bitstream that includes an encoded representation of the video data. Based on a value of the syntax element being equal to a first value (e.g., 0), video decoder 300 may infer that all constraint fields in a general constraint information syntax structure have values indicating that constraints corresponding to the constraint fields do not apply to the bitstream.

In some examples, video decoder 300 may decode a syntax element (e.g., general_constraint_info_present_flag) in a profile tier level syntax structure in a bitstream that includes an encoded representation of the video data. In such examples, the syntax element indicates whether the profile tier level syntax structure includes a general constraint information syntax structure that includes constraint fields that specify whether constraints apply to the bitstream. Based on the syntax element indicating that the profile tier level syntax structure does not include the general constraint information syntax structure, video decoder 300 may infer that all of the constraint fields in the general constraint information structure have values indicating that the constraints do not apply to the bitstream.

Furthermore, in some examples, video decoder 300 (or another unit or device) may perform a bitstream conformance test that determines that the bitstream does not conform to a video coding standard based on the bitstream violating any of the constraints that apply to the bitstream. In some examples, video decoder 300 (or another unit or device) may determine, based on the values of the constraint fields, whether video decoder 300 is configured to decode the bitstream. Based on video decoder 300 being configured to decode the bitstream, video decoder 300 may decode the bitstream.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

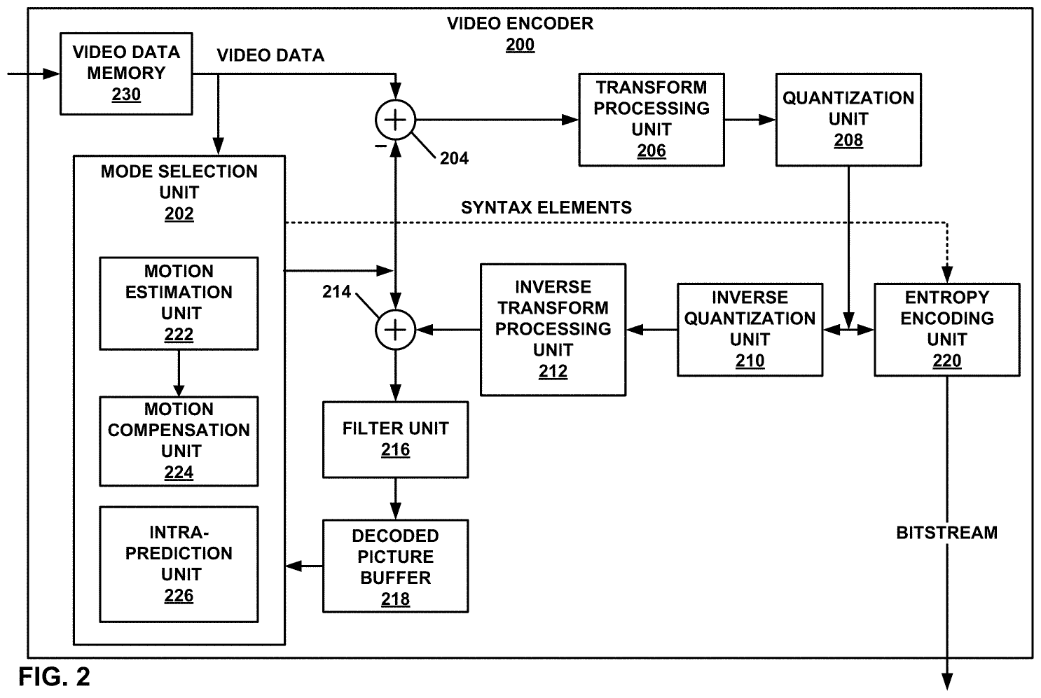

FIG. 2 is a block diagram illustrating an example video encoder 200 that may perform the techniques of this disclosure. FIG. 2 is provided for purposes of explanation and should not be considered limiting of the techniques as broadly exemplified and described in this disclosure. For purposes of explanation, this disclosure describes video encoder 200 according to the techniques of VVC (ITU-T H.266, under development), and HEVC (ITU-T H.265). However, the techniques of this disclosure may be performed by video encoding devices that are configured to other video coding standards.

In the example of FIG. 2, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, of FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 2 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as a few examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

Video encoder 200 stores reconstructed blocks in DPB 218. For instance, in examples where operations of filter unit 216 are not needed, reconstruction unit 214 may store reconstructed blocks to DPB 218. In examples where operations of filter unit 216 are needed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream. In some examples, video encoder 200 may encode the same video data in different ways to generate bitstreams having different profiles, tiers, or levels. Furthermore, video encoder 200 may encode the same video data such that the resulting bitstreams conform to different constraints. Thus, the PTL syntax structures included in these bitstreams may have different values of the profile, level, and tier values, and/or different values corresponding to constraint fields. To help control the amount of data signaled in the PTL syntax structure, when all constraint fields in a general constraint information structure having values indicating that constraints do not apply to the bitstream, video encoder 200 may encode a syntax element in the PTL syntax structure in the bitstream, wherein the syntax element indicates that the PTL syntax structure does not include the constraint fields that specify whether the constraints apply to the bitstream.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying an MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to generate a bitstream that includes an encoded representation of the video data. Based on all constraint fields in a general constraint information structure having values indicating that constraints do not apply to the bitstream, video encoder 200 may encode a syntax element in a profile tier level syntax structure in the bitstream. The syntax element indicates that the profile tier level syntax structure does not include the constraint fields that specify whether the constraints apply to the bitstream.

In some examples, video encoder 200 represents an example of device configured to encode video data including a memory configured to store video data, and one or more processing units implemented in circuitry and configured to signal, based on all constraint fields in a general constraint information structure having values indicating that constraints do not apply to a bitstream that includes an encoded representation of the video data, a syntax element in a profile tier level syntax structure in the bitstream, wherein the syntax element indicates that the profile tier level syntax structure does not include a general constraint information syntax structure that includes constraint fields that specify whether the constraints apply to the bitstream.

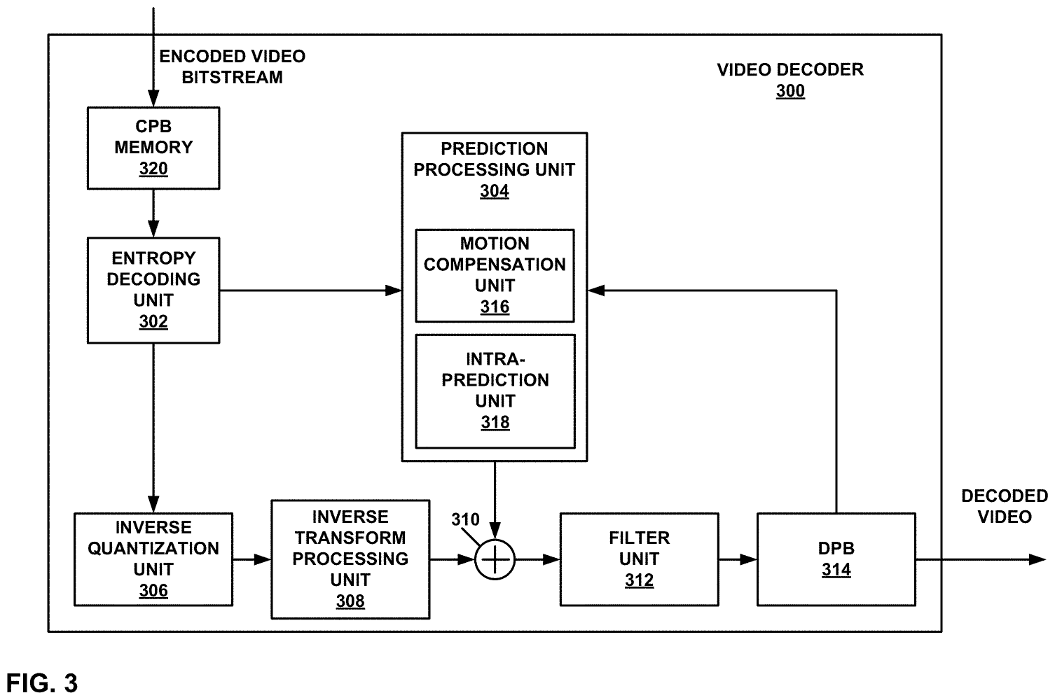

FIG. 3 is a block diagram illustrating an example video decoder 300 that may perform the techniques of this disclosure. FIG. 3 is provided for purposes of explanation and is not limiting on the techniques as broadly exemplified and described in this disclosure. For purposes of explanation, this disclosure describes video decoder 300 according to the techniques of VVC (ITU-T H.266, under development), and HEVC (ITU-T H.265). However, the techniques of this disclosure may be performed by video coding devices that are configured to other video coding standards.

In the example of FIG. 3, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, of FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 3 are illustrated to assist with understanding the operations performed by video decoder 300. The units may be implemented as fixed-function circuits, programmable circuits, or a combination thereof. Similar to FIG. 2, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

In some examples, prior to decoding a bitstream, video decoder 300 (e.g., entropy decoding unit 302) may decode a PTL syntax structure (e.g., from a DCI RBSP, VPS, SPS, or other type of parameter set or RBSP). Video decoder 300 may use information (e.g., profile indicators, tier flags, level indicators, constraint fields, etc.) in the PTL syntax structure to determine whether video decoder 300 is configured to decode other portions of the bitstream. For instance, video decoder 300 may compare the information in the PTL syntax structure to previously defined configuration data for video decoder 300 to determine whether video decoder 300 is configured to decode the other portions of the bitstream.

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 2).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 2). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to decoding a syntax element (e.g., general_constraint_info_present_flag) in a profile tier level syntax structure in a bitstream that includes an encoded representation of the video data. Based on a value of the syntax element being equal to a first value (e.g., 0), the one or more processing units may infer that all constraint fields in a general constraint information syntax structure have values indicating that constraints corresponding to the constraint fields do not apply to the bitstream.

In some examples, video decoder 300 represents an example of a video decoding device including a memory configured to store video data, and one or more processing units implemented in circuitry and configured to decode a syntax element in a profile tier level syntax structure in a bitstream that includes an encoded representation of the video data, wherein the syntax element indicates whether the profile tier level syntax structure includes a general constraint information syntax structure that includes constraint fields that specify whether constraints apply to the bitstream. The one or more processing units may infer, based on the syntax element indicating that the profile tier level syntax structure does not include the general constraint information syntax structure, that all of the constraint fields in the general constraint information structure have values indicating that the constraints do not apply to the bitstream. In some examples, the one or more processors may perform a bitstream conformance test that determines that the bitstream does not conform to a video coding standard based on the bitstream violating any of the constraints that apply to the bitstream.

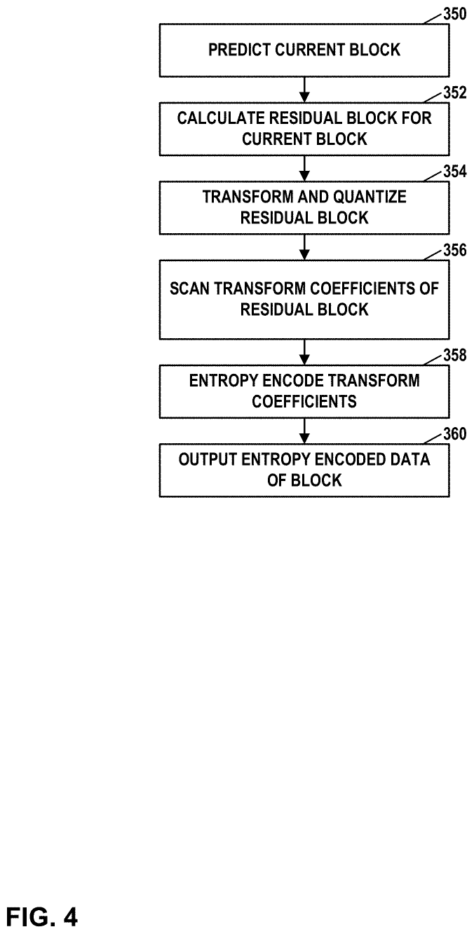

FIG. 4 is a flowchart illustrating an example method for encoding a current block of video data. The current block may include a current CU. Although described with respect to video encoder 200 (FIGS. 1 and 2), it should be understood that other devices may be configured to perform a method similar to that of FIG. 4.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, unencoded block and the prediction block for the current block. Video encoder 200 may then transform the residual block and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

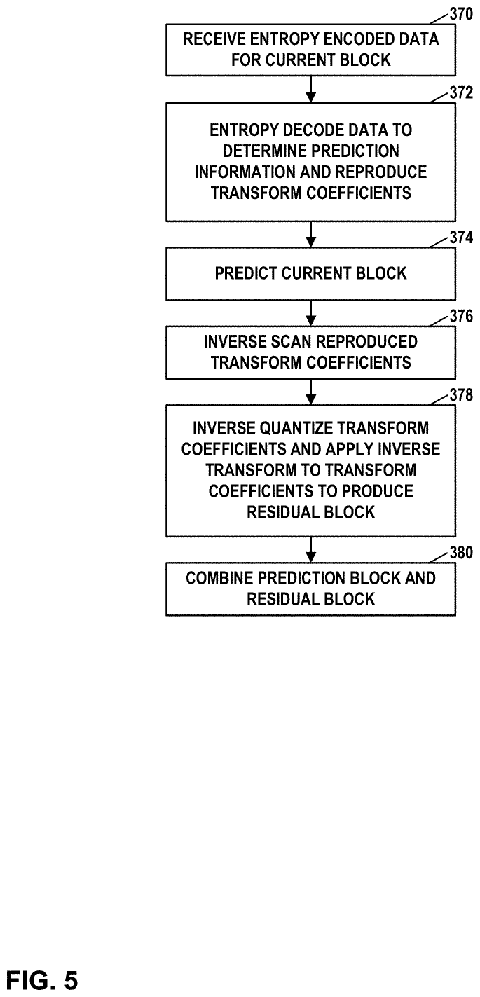

FIG. 5 is a flowchart illustrating an example method for decoding a current block of video data. The current block may include a current CU. Although described with respect to video decoder 300 (FIGS. 1 and 3), it should be understood that other devices may be configured to perform a method similar to that of FIG. 5.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). Video decoder 300 may predict the current block (374), e.g., using an intra- or inter-prediction mode as indicated by the prediction information for the current block, to calculate a prediction block for the current block. Video decoder 300 may then inverse scan the reproduced transform coefficients (376), to create a block of quantized transform coefficients. Video decoder 300 may then inverse quantize the transform coefficients and apply an inverse transform to the transform coefficients to produce a residual block (378). Video decoder 300 may ultimately decode the current block by combining the prediction block and the residual block (380).

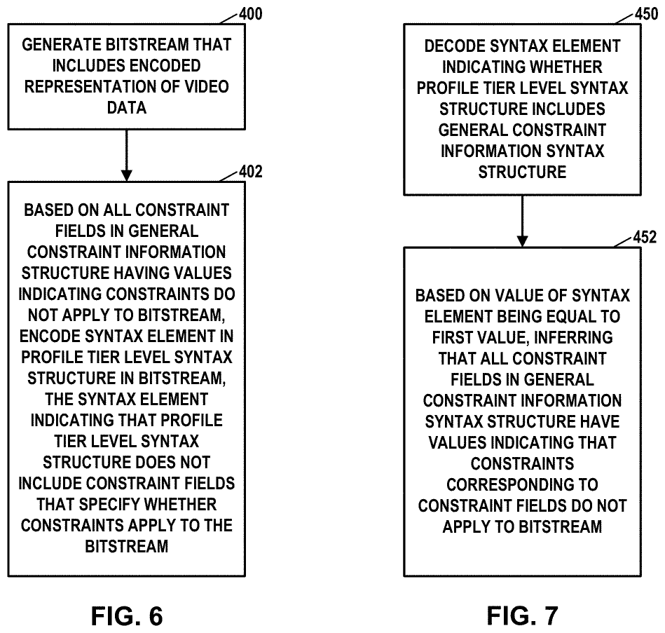

FIG. 6 is a flowchart illustrating an example operation for encoding video data in accordance with one or more techniques of this disclosure. In the example of FIG. 6, video encoder 200 may generate a bitstream that includes an encoded representation of the video data (400). For example, video encoder 200 may generate the bitstream by encoding blocks of pictures of the video data, e.g., as described elsewhere in this disclosure with respect to FIG. 2 and FIG. 4.

Based on all constraint fields in a general constraint information structure having values indicating that constraints do not apply to the bitstream, video encoder 200 may encode a syntax element (e.g., general_constraint_info_present_flag) in a profile tier level syntax structure (e.g., a profile_tier_level( ) syntax structure) in the bitstream (402). The syntax element indicates that the profile tier level syntax structure does not include the constraint fields that specify whether the constraints apply to the bitstream. In this disclosure, a syntax element may be within a first syntax structure even if the syntax element is in a second syntax structure nested within the first syntax structure. Examples of constraint fields may include one or more of the constraint fields corresponding to the constraint flags of Table 2. In some examples, the syntax element indicates whether the profile tier level syntax structure includes a general constraint information syntax structure (e.g., general_constraint_info( )) that includes the constraint fields.

FIG. 7 is a flowchart illustrating an example operation for processing video data in accordance with one or more techniques of this disclosure. Although the operation of FIG. 7 is described with respect to video decoder 300, the operation of FIG. 7 may be performed by other devices, such as intermediate network devices, content delivery network devices, or other types of devices.

In the example of FIG. 7, video decoder 300 may decode a syntax element (e.g., general_constraint_info_present_flag) in a profile tier level syntax structure in a bitstream that includes an encoded representation of the video data (450). For instance, video decoder 300 may parse the bitstream to determine a value of the syntax element.

Based on a value of the syntax element being equal to first value (e.g., 0), video decoder 300 may infer that all constraint fields in a general constraint information syntax structure (e.g., general_constraint_info( )) have values indicating that constraints corresponding to the constraint fields do not apply to the bitstream (452). In other words, based on the value of the syntax element being equal to the first value (e.g., 0), video decoder 300 may automatically determine, without decoding syntax elements specifically indicating, that the constraints corresponding to the constraint fields do not apply to the bitstream. Because video decoder 300 may make this inference, it may be unnecessary for the bitstream to include syntax elements (e.g., no_ciip_constraint_flag, no_palette_constraint_flag, no_gdr_constraint_flag, etc.) corresponding to the constraint fields. On the other hand, if the value of the syntax element is equal to a second value (e.g., 1), video decoder 300 may decode syntax elements indicating the values of the constraint fields. In some examples, the syntax element indicates whether the profile tier level syntax structure includes a general constraint information syntax structure that includes the constraint fields that specify whether constraints apply to the bitstream.

In some examples, a device (e.g., source device 102, destination device 116, a content delivery network device, or another type of device) performs a bitstream conformance test that determines whether the bitstream conforms to a video coding standard (e.g., VVC or another video coding standard). When performing the bitstream conformance test, the device may determine that the bitstream does not conform to a video coding standard when the bitstream violates any of the constraints that apply to the bitstream. The device may perform the bitstream conformance test at least in part by decoding the bitstream and checking whether any values violate constraints imposed on the bitstream.

In some examples, a device (e.g., source device 102, destination device 116, a content delivery network device, or another type of device) determines, based on the values of the constraint fields, whether video decoder 300 is configured to decode the bitstream. For instance, the device may compare values of the constraint fields specified for video decoder 300 to the values of the constraint fields indicated in the profile tier level syntax structure. Based on video decoder 300 being configured to decode the bitstream, video decoder 300 may decode the bitstream. In some instances, based on video decoder 300 being configured to decode the bitstream, the device may forward the bitstream to video decoder 300 for decoding. Video decoder 300 may decode the bitstream, e.g., in the manner described with respect to FIG. 3 or elsewhere in this disclosure.

The following is a non-limiting list of aspects that may be in accordance with one or more techniques of this disclosure.

Aspect 1A: A method of processing video data includes decoding a syntax element in a profile tier level syntax structure in a bitstream that includes an encoded representation of the video data, wherein the syntax element indicates whether the profile tier level syntax structure includes a general constraint information syntax structure that includes constraint fields that specify whether constraints apply to the bitstream; and based on the syntax element indicating that the profile tier level syntax structure does not include the general constraint information syntax structure, inferring that all of the constraint fields in the general constraint information structure have values indicating that the constraints do not apply to the bitstream.

Aspect 2A: The method of aspect 1A, further comprising performing a bitstream conformance test that determines that the bitstream does not conform to a video coding standard based on the bitstream violating any of the constraints that apply to the bitstream.

Aspect 3A: A method of encoding video data includes based on all constraint fields in a general constraint information structure having values indicating that constraints do not apply to a bitstream that includes an encoded representation of the video data, signaling a syntax element in a profile tier level syntax structure in the bitstream, wherein the syntax element indicates that the profile tier level syntax structure does not include a general constraint information syntax structure that includes constraint fields that specify whether the constraints apply to the bitstream.

Aspect 4A: A device for coding video data, the device comprising one or more means for performing the method of any of aspects 1A-3A.

Aspect 5A: The device of aspect 4A, wherein the one or more means comprise one or more processors implemented in circuitry.

Aspect 6A: The device of any of aspects 4A and 5A, further comprising a memory to store the video data.

Aspect 7A: The device of any of aspects 4A-6A, further comprising a display configured to display decoded video data.

Aspect 8A: The device of any of aspects 4A-7A, wherein the device comprises one or more of a camera, a computer, a mobile device, a broadcast receiver device, or a set-top box.

Aspect 9A: The device of any of aspects 4A-8A, wherein the device comprises a video decoder.

Aspect 10A: The device of any of aspects 4A-9A, wherein the device comprises a video encoder.

Aspect 11A: A computer-readable storage medium having stored thereon instructions that, when executed, cause one or more processors to perform the method of any of aspects 1A-3A.

Aspect 1B: A method of processing video data includes decoding a syntax element in a profile tier level syntax structure in a bitstream that includes an encoded representation of the video data; and based on a value of the syntax element being equal to 0, inferring that all constraint fields in a general constraint information syntax structure have values indicating that constraints corresponding to the constraint fields do not apply to the bitstream.

Aspect 2: The method of aspect 1, wherein: the constraint fields specify whether the constraints apply to the bitstream, and the syntax element indicates whether the profile tier level syntax structure includes a general constraint information syntax structure that includes the constraint fields that specify whether the constraints apply to the bitstream.

Aspect 3: The method of any of aspects 1 and 2, further comprising performing a bitstream conformance test that determines that the bitstream does not conform to a video coding standard based on the bitstream violating any of the constraints that apply to the bitstream.

Aspect 4: The method of any of aspects 1 through 3, further includes determining, based on the values of the constraint fields, whether a video decoder is configured to decode the bitstream; and based on the video decoder being configured to decode the bitstream, decoding, by the video decoder, the bitstream.

Aspect 5: A method of encoding video data includes generating a bitstream that includes an encoded representation of the video data; and based on all constraint fields in a general constraint information structure having values indicating that constraints do not apply to the bitstream, encoding a syntax element in a profile tier level syntax structure in the bitstream, wherein the syntax element indicates that the profile tier level syntax structure does not include the constraint fields that specify whether the constraints apply to the bitstream.

Aspect 6: The method of aspect 5, wherein the syntax element indicates that the profile tier level syntax structure does not include a general constraint information syntax structure that includes the constraint fields.

Aspect 7: A device for processing video data includes a memory to store the video data; and one or more processors implemented in circuitry, the one or more processors configured to: decode a syntax element in a profile tier level syntax structure in a bitstream that includes an encoded representation of the video data; and based on a value of the syntax element being equal to 0, infer that all constraint fields in a general constraint information syntax structure have values indicating that constraints corresponding to the constraint fields do not apply to the bitstream.

Aspect 8: The device of aspect 7, wherein: the constraint fields specify whether the constraints apply to the bitstream, and the syntax element indicates whether the profile tier level syntax structure includes a general constraint information syntax structure that includes the constraint fields that specify whether the constraints apply to the bitstream.

Aspect 9: The device of any of aspects 7 and 8, wherein the one or more processors are further configured to perform a bitstream conformance test that determines that the bitstream does not conform to a video coding standard based on the bitstream violating any of the constraints that apply to the bitstream.

Aspect 10: The device of any of aspects 7 through 9, wherein the one or more processors are further configured to: determine, based on the values of the constraint fields, whether a video decoder is configured to decode the bitstream; and based on the video decoder being configured to decode the bitstream, decode the bitstream.

Aspect 11: The device of aspect 10, further comprising a display configured to display video data decoded from the bitstream.

Aspect 12: The device of any of aspects 7 through 11, wherein the device comprises one or more of a camera, a computer, a mobile device, a broadcast receiver device, or a set-top box.

Aspect 13: A device for processing video data includes a memory to store the video data; and one or more processors implemented in circuitry, the one or more processors configured to: generate a bitstream that includes an encoded representation of the video data; and based on all constraint fields in a general constraint information structure having values indicating that constraints do not apply to the bitstream, encode a syntax element in a profile tier level syntax structure in the bitstream, wherein the syntax element indicates that the profile tier level syntax structure does not include the constraint fields that specify whether the constraints apply to the bitstream.

Aspect 14: The device of aspect 13, wherein the syntax element indicates that the profile tier level syntax structure does not include a general constraint information syntax structure that includes the constraint fields.

Aspect 15: The device of any of aspects 13 and 14, wherein the device comprises one or more of a camera, a computer, a mobile device, a broadcast receiver device, or a set-top box.

Aspect 1: A method of processing video data includes decoding a syntax element in a profile tier level syntax structure in a bitstream that includes an encoded representation of the video data; and based on a value of the syntax element being equal to 0, inferring that all constraint fields in a general constraint information syntax structure have values indicating that constraints corresponding to the constraint fields do not apply to the bitstream.

Aspect 2: The method of aspect 1, wherein: the constraint fields specify whether the constraints apply to the bitstream, and the syntax element indicates whether the profile tier level syntax structure includes a general constraint information syntax structure that includes the constraint fields that specify whether the constraints apply to the bitstream.

Aspect 3: The method of aspect 1, further comprising performing a bitstream conformance test that determines that the bitstream does not conform to a video coding standard based on the bitstream violating any of the constraints that apply to the bitstream.

Aspect 4: The method of aspect 1, further includes determining, based on the values of the constraint fields, whether a video decoder is configured to decode the bitstream; and based on the video decoder being configured to decode the bitstream, decoding, by the video decoder, the bitstream.

Aspect 5: A method of encoding video data includes generating a bitstream that includes an encoded representation of the video data; and based on all constraint fields in a general constraint information structure having values indicating that constraints do not apply to the bitstream, encoding a syntax element in a profile tier level syntax structure in the bitstream, wherein the syntax element indicates that the profile tier level syntax structure does not include the constraint fields that specify whether the constraints apply to the bitstream.

Aspect 6: The method of aspect 5, wherein the syntax element indicates that the profile tier level syntax structure does not include a general constraint information syntax structure that includes the constraint fields.

Aspect 7: A device for processing video data includes a memory to store the video data; and one or more processors implemented in circuitry, the one or more processors configured to: decode a syntax element in a profile tier level syntax structure in a bitstream that includes an encoded representation of the video data; and based on a value of the syntax element being equal to 0, infer that all constraint fields in a general constraint information syntax structure have values indicating that constraints corresponding to the constraint fields do not apply to the bitstream.

Aspect 8: The device of aspect 7, wherein: the constraint fields specify whether the constraints apply to the bitstream, and the syntax element indicates whether the profile tier level syntax structure includes a general constraint information syntax structure that includes the constraint fields that specify whether the constraints apply to the bitstream.

Aspect 9: The device of aspect 7, wherein the one or more processors are further configured to perform a bitstream conformance test that determines that the bitstream does not conform to a video coding standard based on the bitstream violating any of the constraints that apply to the bitstream.

Aspect 10: The device of aspect 7, wherein the one or more processors are further configured to: determine, based on the values of the constraint fields, whether a video decoder is configured to decode the bitstream; and based on the video decoder being configured to decode the bitstream, decode the bitstream.

Aspect 11: The device of aspect 10, further comprising a display configured to display video data decoded from the bitstream.

Aspect 12: The device of aspect 7, wherein the device comprises one or more of a camera, a computer, a mobile device, a broadcast receiver device, or a set-top box.

Aspect 13: A device for processing video data includes a memory to store the video data; and one or more processors implemented in circuitry, the one or more processors configured to: generate a bitstream that includes an encoded representation of the video data; and based on all constraint fields in a general constraint information structure having values indicating that constraints do not apply to the bitstream, encode a syntax element in a profile tier level syntax structure in the bitstream, wherein the syntax element indicates that the profile tier level syntax structure does not include the constraint fields that specify whether the constraints apply to the bitstream.

Aspect 14: The device of aspect 13, wherein the syntax element indicates that the profile tier level syntax structure does not include a general constraint information syntax structure that includes the constraint fields.

Aspect 15: The device of aspect 13, wherein the device comprises one or more of a camera, a computer, a mobile device, a broadcast receiver device, or a set-top box.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of processing video data, the method comprising:
decoding a syntax element in a profile tier level syntax structure in a bitstream that includes an encoded representation of the video data; and
based on a value of the syntax element being equal to 0, inferring that all constraint fields in a general constraint information syntax structure have values indicating that constraints corresponding to the constraint fields do not apply to the bitstream.

2. The method of claim 1, wherein:
the constraint fields specify whether the constraints apply to the bitstream, and
the syntax element indicates whether the profile tier level syntax structure includes a general constraint information syntax structure that includes the constraint fields that specify whether the constraints apply to the bitstream.

3. The method of claim 1, further comprising performing a bitstream conformance test that determines that the bitstream does not conform to a video coding standard based on the bitstream violating any of the constraints that apply to the bitstream.

4. The method of claim 1, further comprising:
determining, based on the values of the constraint fields, whether a video decoder is configured to decode the bitstream; and
based on the video decoder being configured to decode the bitstream, decoding, by the video decoder, the bitstream.

5. A method of encoding video data, the method comprising:
generating a bitstream that includes an encoded representation of the video data; and
based on all constraint fields in a general constraint information structure having values indicating that constraints do not apply to the bitstream, encoding a syntax element in a profile tier level syntax structure in the bitstream, wherein the syntax element indicates that the profile tier level syntax structure does not include the constraint fields that specify whether the constraints apply to the bitstream.

6. The method of claim 5, wherein the syntax element indicates that the profile tier level syntax structure does not include a general constraint information syntax structure that includes the constraint fields.

7. A device for processing video data, the device comprising:
a memory to store the video data; and
one or more processors implemented in circuitry, the one or more processors configured to:
decode a syntax element in a profile tier level syntax structure in a bitstream that includes an encoded representation of the video data; and
based on a value of the syntax element being equal to 0, infer that all constraint fields in a general constraint information syntax structure have values indicating that constraints corresponding to the constraint fields do not apply to the bitstream.

8. The device of claim 7, wherein:
the constraint fields specify whether the constraints apply to the bitstream, and
the syntax element indicates whether the profile tier level syntax structure includes a general constraint information syntax structure that includes the constraint fields that specify whether the constraints apply to the bitstream.

9. The device of claim 7, wherein the one or more processors are further configured to perform a bitstream conformance test that determines that the bitstream does not conform to a video coding standard based on the bitstream violating any of the constraints that apply to the bitstream.

10. The device of claim 7, wherein the one or more processors are further configured to:
determine, based on the values of the constraint fields, whether a video decoder is configured to decode the bitstream; and
based on the video decoder being configured to decode the bitstream, decode the bitstream.

11. The device of claim 10, further comprising a display configured to display video data decoded from the bitstream.

12. The device of claim 7, wherein the device comprises one or more of a camera, a computer, a mobile device, a broadcast receiver device, or a set-top box.

13. A device for processing video data, the device comprising:
a memory to store the video data; and
one or more processors implemented in circuitry, the one or more processors configured to:
generate a bitstream that includes an encoded representation of the video data; and
based on all constraint fields in a general constraint information structure having values indicating that constraints do not apply to the bitstream, encode a syntax element in a profile tier level syntax structure in the bitstream, wherein the syntax element indicates that the profile tier level syntax structure does not include the constraint fields that specify whether the constraints apply to the bitstream.

14. The device of claim 13, wherein the syntax element indicates that the profile tier level syntax structure does not include a general constraint information syntax structure that includes the constraint fields.

15. The device of claim 13, wherein the device comprises one or more of a camera, a computer, a mobile device, a broadcast receiver device, or a set-top box.
